(19) United States
(12) Patent Application Publication
(10) Pub. No.: US 2021/0299695 A1
(43) Pub. Date: Sep. 30, 2021

(54) SELF-PUNCTURE NOZZLE FOR CAULKING

(71) Applicant: Inno-Cons Thailand Co., Ltd., Pathumthani (TH)

(72) Inventor: Karn KHAM-ORN, Chachoengsao (TH)

(21) Appl. No.: 17/073,424

(22) Filed: Oct. 19, 2020

(30) Foreign Application Priority Data
Mar. 31, 2020 (TH) 2001001896

(51) Int. Cl. B05C 17/005; B05B 1/10; B05B 15/65; B05C 17/015

(52) U.S. Cl. CPC B05C 17/00513; B05B 1/10; B05C 17/015; B05C 17/00593; B05B 15/65

(57) ABSTRACT

The invention relates to devices and methods of a puncturing nozzle head for safe and efficient release of fluid when used in assembly with a caulking device or any other fluid dispensing devices. The puncturing nozzle head is disposed over a barrel of the caulking device as a cap. The puncturing nozzle head is formed of a dispensing tube with a base plate. For example, the dispensing tube may be a conical shaped tube extending from the base plate. A plurality of puncturing rods may be disposed at an inner surface of the base plate. For example, the puncturing rods are configured to puncture a sausage pack containing caulking material which is loaded into the barrel of the caulking device. A nozzle head lock ring is provided to lock the nozzle head in position to the barrel.

### CROSS-REFERENCE TO RELATED APPLICATION

This application claims the benefit of a Thailand Patent Application No. 2001001896, filed on Mar. 31, 2020, the disclosure of which is herein incorporated by reference in its entirety for all purposes.

### FIELD OF THE INVENTION

The present disclosure relates to fluid dispensing devices and methods. In particular, the present disclosure relates to devices and methods of a puncturing nozzle head for safe and efficient release of fluid when used in assembly with a caulking device or any other fluid dispensing devices.

### BACKGROUND

A caulking tool is commonly used for dispensing and applying a caulking material to seal off gaps in structure surfaces. Caulking material can be any types of sealants or adhesives. The caulking material may be provided in a cartridge or a foil-pack. A foil-pack may be commonly referred to as a sausage pack. The cartridge or foil-pack enables caulking material to be easily loaded into the caulking tool for dispensing.

The use of the foil-pack is generally a more environmental-friendly alternative to cartridges due to its recyclable aluminum packing material. Further, the use of the foil-pack results in about 95% less waste. However, users are discouraged from using foil-packs due to their inconveniences during processing. Unlike cartridges, a foil-pack requires an operator to perform an additional step. For example, a user after partially loading the foil pack into the caulking tool, needs to unseal it by cutting an opening in the foil-pack before completing the loading process. The cutting of the foil-pack is required in order for the caulking material to be released from the foil-pack and dispensed through the nozzle. A cutting tool, such as a cutter or scissors, may be used to create the opening in the foil-pack.

This increases the number of manual steps during the operation and slows down operator's efficiency. Further, due to the need for the use of sharp tools, such as cutters or scissors, it imposes additional risk hazard on the operators. Because of the potential risk hazard, operators may have to include extra precautionary steps within a workflow process, therefore further slowing down work efficiency. This is more so in industries which have to adhere to strict standard operating procedures (SOPs). In addition, if incidents do happen, there is also unnecessary work burden on the safety management to generate incident reporting to account for the occupational hazards.

Therefore, based on the foregoing discussion, there is a desire to provide a device and method of a puncturing nozzle head for safe and efficient release of fluid when used in assembly with a caulking device or any other fluid dispensing devices.

### SUMMARY

Embodiments generally relate to a device and method of a puncturing nozzle head for safe and efficient release of fluid when used in assembly with a caulking device or any other fluid dispensing devices.

In one embodiment, a caulking device assembly includes a barrel having a first barrel end and a second barrel end. The barrel is configured to contain a sausage pack sealed with caulking material. The assembly also includes a nozzle head including a base plate having top and bottom surfaces, a dispensing tube extending from the top surface of the base plate. The dispensing tube has a first end opening at the top surface of the base plate and a second end opening opposing the first end opening. The nozzle head further includes a plurality of puncturing rods disposed on the bottom surface of the base plate. The assembly also includes a nozzle head lock ring, the nozzle head lock ring is configured to lock the nozzle head in position at the second barrel end, and the puncturing rods at the bottom surface of the base plate is configured to puncture the sausage pack when the sausage pack is pressed against the puncturing rods to release the caulking material for dispensing out through the second end opening of the dispensing tube.

In another embodiment, a nozzle head of a caulking tool includes a base plate having top and bottom surfaces, a dispensing tube extending from the top surface of the base plate. The dispensing tube having a first end opening at the top surface of the base plate and a second end opening opposing the first end opening. The nozzle head further includes a plurality of puncturing rods disposed on the bottom surface of the base plate, and when the nozzle head is fitted onto a caulking tool loaded with a sausage pack sealed with caulking material, the puncturing rods are configured to pierce the sausage pack pressed into the puncturing rods to dispense the caulking material through the second end opening of the dispensing tube.

In yet another embodiment, a method of dispensing caulking material from a caulking device assembly includes loading a sausage pack sealed with caulking material into a barrel of a caulking tool, locking a nozzle head to a second barrel end of the barrel, and the nozzle head includes a base plate having top and bottom surfaces, a dispensing tube extending from the top surface of the base plate. The dispensing tube has a first end opening at the top surface of the base plate and a second end opening opposing the first end opening. The nozzle head also includes a plurality of puncturing rods disposed on the bottom surface of the base plate, wherein the puncturing rods face the sausage pack. The method further includes actuating the caulking tool which presses the sausage pack into the puncturing rods to puncture the sausage pack to dispense the caulking material through the second end opening of the dispensing tube.

These and other advantages and features of the embodiments herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1 illustrates exploded views of an exemplary embodiment of a caulking gun assembly;

FIGS. 2a-f show front and bottom perspective views of various exemplary embodiments of a nozzle head;

FIGS. 3a-b show side and bottom views of an exemplary embodiment of a nozzle head; and

FIG. 4 shows views of various exemplary embodiments of a nozzle head lock ring.

### DETAILED DESCRIPTION

Embodiments described herein generally relate to fluid dispensing devices and methods. In particular, the present disclosure relates to devices and methods of a puncturing nozzle head for safe and efficient release of fluid when used in assembly with a caulking device or any other fluid dispensing devices.

As discussed, a caulking assembly is commonly employed to dispense or discharge fluid prepacked in foil-packs. The foil-pack is loaded into the caulking assembly and unsealed before the fluid can be released and dispensed or discharged through a nozzle of the caulking assembly.

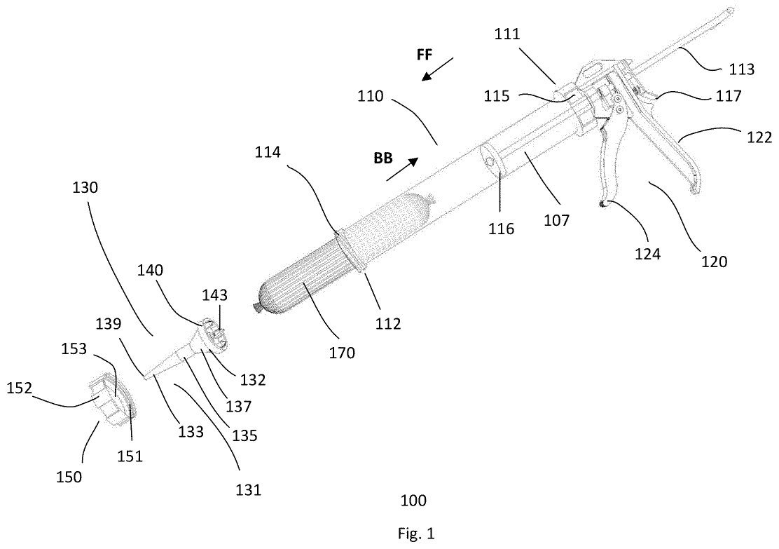

FIG. 1 illustrates exploded views of an exemplary embodiment of a caulking tool or gun 100. The caulking tool or gun may include various components which are assembled. The caulking tool or gun may be referred to as a caulking tool or gun assembly.

Referring to FIG. 1, the caulking gun 100 is configured for accommodating a foil-pack or sausage pack 170 containing caulking material. The caulking tool includes a barrel 110. The barrel, for example, may be an elongated tubular housing configured to accommodate a sausage pack 170. The barrel includes openings at first and second barrel ends 111 and 112. The length and diameter of the barrel should be sufficient to fully accommodate the sausage pack when the caulking gun is assembled and loaded. For example, a length L of the barrel should be longer than a length 1 of the sausage pack and an inner diameter D of the barrel should be larger than a diameter d of the sausage pack.

The barrel is fitted onto a caulking tool base 120. For example, the caulking tool base includes a base mount 115 to which the first barrel end is coupled. The first barrel end may include a first barrel end coupler and the base mount may be configured with a base coupler. The first barrel end coupler may be a male coupler and the base coupler may be a female coupler. The couplers, for example, may be configured for coupling to each other. The couplers may be threaded couplers. Rotating the barrel in a first direction may lock the barrel to the caulking tool base whereas rotating the barrel in a second direction may decouple the barrel from the caulking tool base. Other types of couplers, such as twist lock couplers, may also be useful for mounting the barrel to the caulking tool base.

The caulking tool base may include a handle 122 to facilitate holding the tool by a user. The caulking tool base is configured to accommodate a plunger or piston 107. The plunger, for example, is slidably mounted onto the caulking tool base. The plunger includes a plunger rod 113 and a plunger plate 116 mounted on a first rod end of the plunger rod. The plunger plate is configured to fit within the barrel. In one embodiment, the plunger plate Dₚ has a plate diameter which is slightly smaller than the inner diameter D of the barrel. The plunger is configured to enable the first end of the plunger rod with the plunger plate to traverse the length of the barrel in both directions. For example, the plunger plate traverses from the first barrel end to the second barrel end in the FF direction and back in the BB direction.

The caulking tool base includes an actuator or trigger 124. The actuator, for example, may be configured to operate in first and second modes. For example, the actuator is configured to operate in a dispense mode or a non-dispense mode. In the dispense mode, the actuator causes the plunger to move in the FF direction when actuated. In the non-dispense mode, the actuator does not cause the plunger to move in the FF direction when actuated. In one embodiment, the caulking tool base may include a locking device 117. The locking device allows the plunger rod 113 to move in the forward direction FF when the actuator or trigger 124 is depressed in the dispense mode. As such, the locking device 117 prevents back-pressure from forcing the rod backwards.

As shown, the caulking gun is a mechanically operated caulking gun. For example, the plunger rod can be rotated to be in the dispense mode position, engaging the actuator. Pressing the actuator towards the handle causes a cranking motion to move the plunger in the FF direction. When the actuator is released, a plunger position lock keeps the plunger rod in position. By continuing to press and release the actuator, the plunger rod keeps moving in the FF direction with each press and maintains its position after each release. To move the plunger rod backwards in the BB direction, the locking device 117 is depressed to unlock the plunger rod 113 to move freely by manually pulling the end of the plunger rod backwards.

In other embodiments, the caulking gun may be a powered caulking gun. For example, the caulking gun may be an electrically or pneumatically operated caulking gun. In the dispense mode, the caulking gun may be actuated to move the plunger in the FF direction. In the non-dispense mode, the caulking gun may be actuated to move the plunger in the BB direction. Other configurations of operating the caulking gun may also be useful.

A nozzle head 130 is provided at the second barrel end 112. The nozzle head includes a dispensing tube 131 with a base plate 132. An end or tip of the dispensing tube has an exit opening 139 through which caulking material is dispensed from the caulking gun. The dispensing tube is a conical shaped tube extending from the base plate. A diameter of the dispensing tube is the largest at the base plate and smallest at the tip. In one embodiment, the dispensing tube may include multiple portions. For example, the tube may include conical and vertical portions. The conical portions may have different slopes. The conical portions proximate to the base have shallower slopes while the conical portions distal from the base have steep slopes.

As shown, the dispensing tube includes, from the top, a conical first portion 133 with the tip 139, a vertical second portion 135 and a conical third portion 137 with the base plate 132. The conical first portion is configured with a steeper slope than the conical third portion. Providing the dispensing head with other numbers or configurations of portions may also be useful.

In one embodiment, a nozzle head lock ring 150 is provided to lock the nozzle head in position. The nozzle head lock ring serves as a cap which can be coupled to the second barrel end. For example, the nozzle head lock ring includes a lock ring plate 152 with a lock ring coupler 151. The lock ring coupler is configured to be mated to a second barrel end coupler 114 at the second barrel end 112. This facilitates to lock the nozzle head lock ring, together with the nozzle head, to the second barrel end. The lock ring coupler may be a male coupler and the second barrel end coupler may be a female coupler. The couplers, for example, may be configured for coupling to each other. The couplers may be threaded couplers. Rotating the nozzle head lock ring in a first direction may lock the nozzle head lock ring into position whereas rotating the nozzle head lock ring in a second direction may decouple the nozzle head lock ring from the second barrel end. Other types of couplers, such as twist lock couplers, may also be useful for coupling the nozzle head lock ring to the barrel. In one embodiment, the lock ring plate includes a dispensing tube hole 153 through which the dispensing tube of the nozzle head fits through.

In one embodiment, the nozzle head is configured as a self-puncturing nozzle head. For example, the nozzle head is configured to puncture the sausage pack. This avoids the need for the user to manually puncture the sausage pack prior to loading it into the caulking gun.

In one embodiment, an inner surface of the base plate of the nozzle head is provided with a puncturing rod 143. For example, a puncturing rod is configured to puncture the sausage pack when the sausage pack is pushed against the puncturing rod. The puncturing rod should be configured with sufficient mechanical strength to enable it to puncture the sausage pack while maintaining its integrity. A puncturing rod, for example, includes a post with a pointed tip. The post, as shown, is a rectangular-shaped post. For example, the rectangular-shaped post may have a height of 10 mm and a base area of 48 mm². As for the pointed tip, it may have a height of 8 mm. For example, a total height of the puncturing rod is 18 mm. Providing other dimensions for the rectangular-shaped post and the pointed tip may also be possible. Other cross-sectional shaped posts may also be useful. For example, the post may be a circular-shaped post or may be formed of other geometric shapes.

In one embodiment, a plurality of puncturing rods 143 is provided on the inner surface of the base plate. As shown, four puncturing rods are provided. The puncturing rods are distributed on the inner surface of the base plate. In one embodiment, the puncturing rods may be uniformly distributed on the inner surface of the base plate. Other numbers or configurations of the puncturing rods may also be useful. To pierce the sausage pack, the plunger, when activated by the actuator, forces the sausage pack into the puncturing rods. Once the sausage pack is pierced, caulking material can escape for dispensing by the caulking gun.

In one embodiment, the nozzle head may be provided with a retainer 140. The retainer, for example, is a wall disposed along a circumference of the base plate. The retainer forms a tube surrounding the puncturing rods. Depending on the configuration of the base plate, the retainer and the base plate may form an edge or may be flushed. The retainer is configured to couple the nozzle head to the second barrel end. For example, the retainer is a male coupler configured to be inserted into the barrel. In one embodiment, the retainer is configured to contain one end of the sausage pack.

The nozzle head may be a universal nozzle head. For example, the nozzle head may be mounted to any conventional barrel to form part of the caulking device. Alternatively, providing a nozzle head customized to fit a barrel with specific dimensions may also be useful.

In one embodiment, the nozzle head is an integrated or single piece. For example, various components of the nozzle head, such as the first, second and third portions, the base plate and the retainer, are formed as a single piece part. Alternatively, the various components are formed separately and later integrated to form a single piece. In one embodiment, the puncturing rods are formed separately before they are integrated with the nozzle head. In another embodiment, the nozzle head with the puncturing rods is formed as a single piece. In one embodiment, the nozzle head is formed of a rigid material, such as a rigid plastic. The plastic nozzle head may be molded into shape. For example, using molding techniques such as casting or injection molding. Other types of rigid materials as well as other forming techniques, such as 3D-printing may also be useful. The same material and technique used to form the nozzle head may also be employed to form the puncturing rods. For example, the puncturing rods are made of plastic shaped by molding techniques such as injection molding. Alternatively, other materials and techniques for forming the puncturing rods may also be utilized.

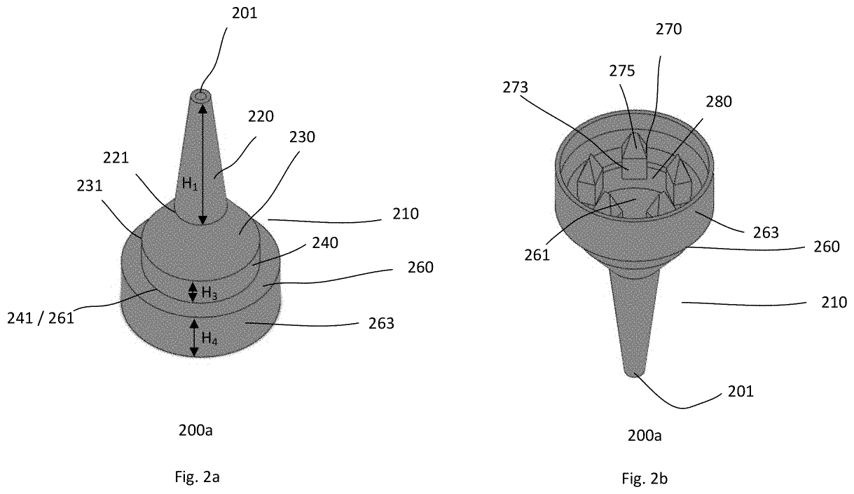

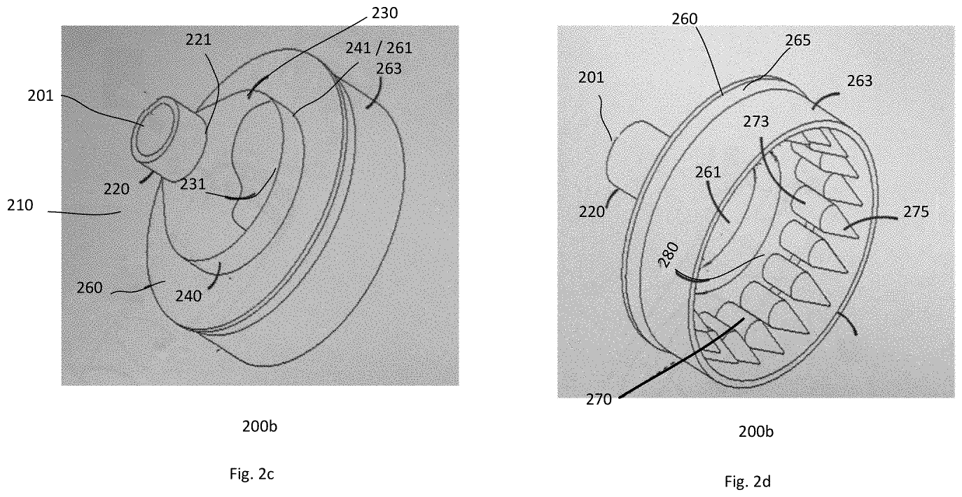

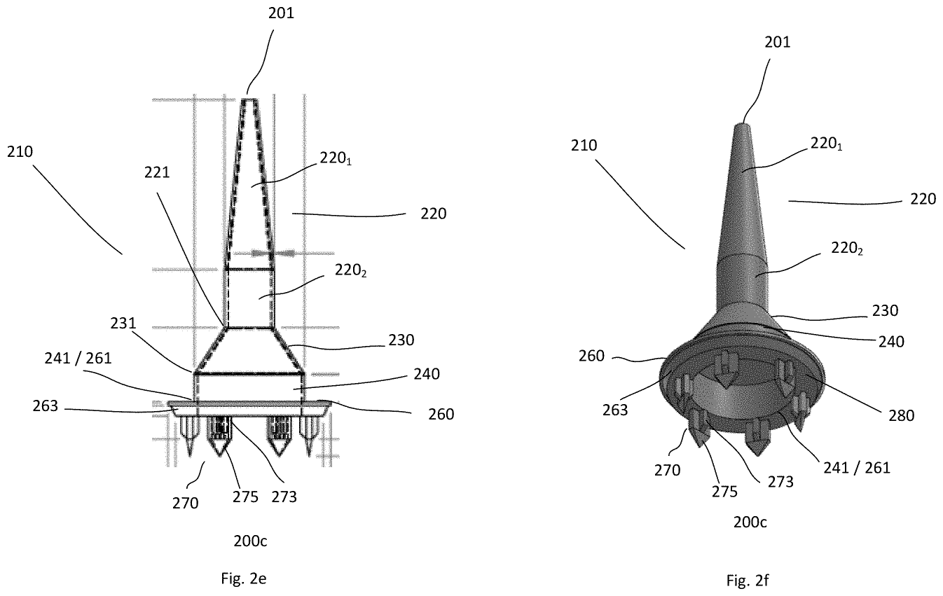

FIGS. 2a-f show front and bottom perspective views of various exemplary embodiments of nozzle heads 200a-c. Nozzle heads 200a-c share similar features except for some differences which will be further described in later paragraphs.

As already discussed, the nozzle head is disposed at the second barrel end of the barrel. For example, the nozzle head facilitates as a cap cover that keeps the sausage pack within the barrel. In one embodiment, the nozzle head is removably associated with the barrel or the caulking gun. For example, the nozzle head is not an integrated part of the barrel or the caulking gun. In one embodiment, the nozzle head may be formed as a universal nozzle head. For example, the nozzle head can be mounted to a barrel of any conventional caulking gun. Alternatively, providing a nozzle head customized to fit a barrel with specific dimensions may also be useful.

As shown, the nozzle head may include a dispensing tube 210 with a base plate 260. An end or tip of the dispensing tube includes an exit opening or nozzle outlet 201. For example, the dispensing tube dispenses caulking material out from the nozzle outlet 201. Providing a dispensing tube with more than one nozzle outlet may also be useful. In one embodiment, the dispensing tube is a conical shaped tube extending from the base plate. For example, a diameter of the tube is the largest at the base plate and smallest at the tip. In one embodiment, the dispensing tube may include multiple portions. For example, the tube may include conical and vertical portions. In FIGS. 2a-b, the dispensing tube includes a conical first portion 220 from the tip, a conical second portion 230 and a vertical third portion 240 with the base plate. The multiple portions are configured to form a continuous fluid passage within the dispensing tube. For example, the multiple portions are configured to contain caulking material before it is dispensed out from the nozzle outlet. Alternatively, providing other configurations of forming the dispensing tube may also be useful.

As illustrated, the exit opening or nozzle outlet 201 is disposed at a tip of the conical first portion 220. In one embodiment, the conical first portion has a steep tapered profile. For example, the profile tapers towards the nozzle outlet. For example, the nozzle outlet has the smallest diameter. A diameter of the nozzle outlet may be 2 mm while a second end 221 of the conical first portion which is opposite of the nozzle outlet has a diameter of 14 mm. Providing other dimensions for the tapered profile of the conical first portion may also be useful. The tapered profile guides the caulking material to converge towards the nozzle outlet. This maintains pressure build-up within the fluid passage for faster purging or dispensing of the caulking material. Moreover, fluid clogging within the dispensing tube may also be minimized. As a result, smooth fluid discharge is achieved. In one embodiment, the conical first portion has a height H₁ of 50 mm. For example, the height allows for steep tapering of the conical first portion. Forming a conical first portion with other heights may also be useful.

Alternatively, providing a first portion that is not conical may also be useful. For example, as shown in FIGS. 2c-d, the first portion may be a vertical first portion. Forming a first portion with other shapes such as a sphere, an ellipsoid, a spheroid, a paraboloid, or a cylinder may also be useful. In one embodiment, the first portion may be a hybrid first portion. For example, in FIGS. 2e-f, the hybrid first portion 220 includes a combination of a top conical portion 220₁ and a bottom vertical portion 220₂. Such configuration allows the first portion to have a deeper depth (or greater height) and still maintains its steep profile for pressure buildup within the dispensing tube. For example, the hybrid first portion may have a total height of 78.5 mm, with the conical portion 220₁ having a height of 58.5 mm and the vertical portion 220₂ having a height of 20 mm. Providing other configurations and dimensions to form the hybrid first portion may also be possible.

The second end 221 of the first portion is connected to the conical second portion 230. For example, an inside of the first portion is continuous with an inside of the conical second portion. The inside of the conical second portion, for example, forms part of the fluid passage of the dispensing tube. In one embodiment, the conical second portion has a shallow tapered profile. For example, the conical second portion has a shallower slope than the conical first portion. A second end 231 of the conical second portion which is opposite of the second end 221 of the first portion may have a larger diameter of 38 mm. Providing other dimensions for the tapered profile of the conical second portion may also be useful. In one embodiment, the conical second portion has a height H₂ (not shown) of 15 mm. Utilizing a conical second portion with other heights may also be useful. As mentioned, a tapered profile provides a sloping wall for a better fluid flow. For example, the sloping wall allows the caulking material to converge towards the tip of the dispensing tube. As such, pressure build-up within the fluid passage is maintained. Alternatively, forming a second portion shaped as a sphere, an ellipsoid, a spheroid, a paraboloid, or a cylinder may also be possible.

The last vertical third portion 240 is connected to the second end 231 of the conical second portion. For example, an inside of the vertical third portion is continuous with that of the first and second portions. As such, the multiple portions form a continuous fluid communication within the dispensing tube. As the last portion has a vertical portion, a second end 241 of the vertical third portion, opposite of the second end 231 of the conical second portion, has a same diameter as the second end of the conical second portion. For example, a diameter of the second end of the vertical third portion is 38 mm. In one embodiment, the vertical third portion has a height H₃ of 10 mm. Utilizing a vertical third portion with other heights may also be useful. Providing a third portion shaped in other shapes such as a cone, a sphere, an ellipsoid, a spheroid, a paraboloid, or a cylinder may also be possible.

As for the base plate 260 of the nozzle head, it is disposed below the vertical third portion 240. In one embodiment, the base plate includes a base plate opening 261 configured to receive the vertical third portion. For example, the base plate opening has a diameter same as or similar to the diameter of the third vertical portion. For example, the base plate opening connects the base plate to the vertical third portion. Depending on the configuration of the base plate, the base plate opening may or may not be disposed at a center of the base plate.

In one embodiment, the base plate has a diameter larger than the second end of the vertical third portion. For example, the base plate forms an edge around the second end of the third vertical portion. In one embodiment, the diameter of the base plate is the same as or similar to an outside diameter of the barrel. For example, when the nozzle head is disposed over the second barrel end, the base plate ensures that the multiple portions of the dispensing tube do not pass through the barrel. For example, the multiple portions remain above and outside of the second barrel end. In one embodiment, the diameter of the base plate may be 56 mm. Alternatively, a base plate with other diameters may also be employed. For example, when the nozzle head is disposed over the second barrel end, the base plate is configured to be flushed with the inner wall of the barrel. For example, the diameter of the base plate is the same or similar to the inside diameter of the barrel.

In one embodiment, the nozzle is a self-puncturing nozzle head. For example, the nozzle head includes a plurality of puncturing rods 270 configured to puncture the sausage pack. For example, when the actuator of the caulking gun is activated, the sausage pack is pushed towards the nozzle head so that the puncturing rods can puncture a front end of the sausage pack. Once the sausage pack is pierced, caulking material can escape for dispensing.

In one embodiment, a puncturing rod 270 includes a post 273 with a pointed tip 275. For example, a total height of the puncturing rod is 18 mm. Providing other heights for the puncturing rod may also be possible. As shown in FIGS. 2a-d, the post may be a rectangular-shaped post. Other cross-sectional shaped posts may also be useful. For example, the post may be shaped in the form of a cross as illustrated in FIGS. 2e-f. Providing a circular-shaped post or a post formed of other geometric shapes may also be useful. The puncturing rod should be configured with sufficient mechanical strength to enable it to puncture the sausage pack while maintaining its integrity. For example, the material used to form the punching rod is hard enough to puncture through the packaging material of the sausage pack. In one embodiment, the puncturing rods are made of the same material as the nozzle head. For example, the punctuating rod may be formed from plastic. Alternatively, providing any material that can puncture the sausage pack may also be useful.

As shown, the puncturing rods 270 are disposed below an inner surface of the base plate. For example, in FIGS. 2b, 2d and 2f, the puncturing rods are disposed around a support rim 280 on the inner surface of the base plate. For example, the puncturing rods 270 are distributed equally around the support rim 280. The support rim 280 is a region between the base plate opening and an edge of the base plate and is configured to support the puncturing rods disposed thereto. Referring to FIG. 2b, five puncturing rods are disposed around a support rim 280 on the inner surface of the base plate. Alternatively, more than five puncturing rods may be provided, as illustrated in FIGS. 2d and 2f. In one embodiment, any number of puncturing rods may be utilized as long as the number provides sufficient strength to create openings on the sausage pack. For example, more than five puncturing rods may be employed to create more openings on the sausage pack for faster dispensing. For a slower release rate, providing less than five puncturing rods may be useful.

In one embodiment, the nozzle head may be provided with a retainer 263. The retainer, for example, is a wall disposed along a circumference of the base plate. The retainer forms a tube surrounding the puncturing rods.

The retainer is configured to couple the nozzle head to the second barrel end. For example, the retainer serves as a male coupler to be inserted into the barrel. In one embodiment, as seen in FIGS. 2a-d, the height of the retainer provides sufficient depth such that the puncturing rods do not protrude out from the nozzle head. For example, the base plate together with the retainer houses the puncturing rods. The retainer may have a height H₄ of 18 mm. During coupling of the nozzle head to the second barrel end of the barrel, the retainer is flushed with the inner wall of the barrel. In this case, the retainer has a diameter that is same as or similar to the inside of the barrel. Alternatively, providing a retainer with other configurations or heights may also be useful. For example, in FIGS. 2e-f, the retainer may have a height that exposes the puncturing rods of the nozzle head. For example, the retainer has a shorter height than the height of the puncturing rods. For example, H₄ may be 3.5 mm. Unlike previous configuration, the retainer is not configured to be flushed with the inner wall of the barrel when the nozzle head is coupled to the barrel. Instead, an edge of the retainer is aligned with an edge of the second barrel end. For example, the retainer includes a tapered edge. For example, outer and inner diameters of the tapered edge of the retainer align respectively to the outside and inside diameters of the barrel.

Depending on the configuration of the base plate, the retainer and the base plate may form an edge or may be flushed. For example, referring back to FIGS. 2a-b, the retainer is flushed with an edge of the base plate. The retainer and the base plate may have same or similar diameters. Alternatively, the retainer and the base plate may form an edge. For example, as shown in FIGS. 2c-d, the base plate forms a surrounding extension 265 around the edge of the retainer. In this case, the retainer has a smaller diameter than the base plate. Providing other configurations between the base plate and the retainer may also be useful.

In one embodiment, the retainer is configured to contain a front end of the sausage pack. For example, the retainer serves to receive a front end of the sausage pack when the sausage pack is pushed forward by the plunger. The retainer facilitates aligning the front end of the sausage pack towards the fluid passage in the dispensing tube. For example, when caulking material escapes from the pierced sausage pack, the caulking material is guided to flow through the fluid passage and exit from the nozzle outlet.

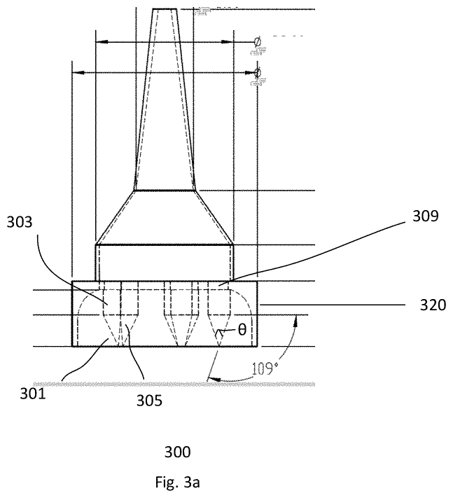

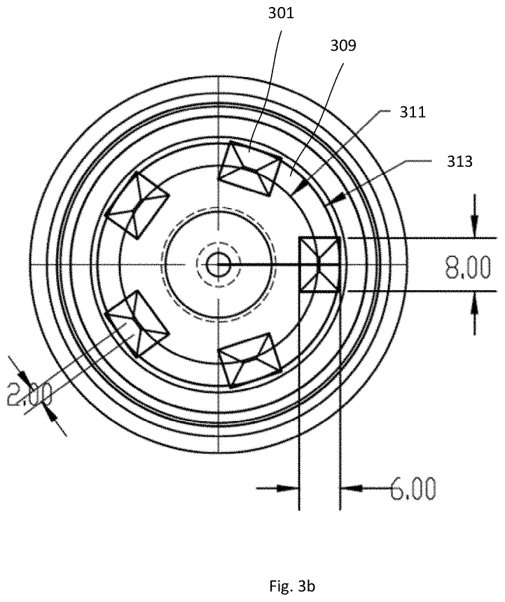

FIGS. 3a-b show side and bottom views of an exemplary embodiment of a nozzle head 300. The nozzle head is similar to the nozzle head described in FIGS. 1, and 2a-f. Common features will not be described or described in detail.

In one embodiment, as shown, the puncturing rods 301 are not exposed. For example, they do not extend out of the retainer 320. Alternatively, providing a nozzle head with exposed puncturing rods may also be useful. As discussed, a puncturing rod may include a post 303 with a pointed tip 305. For example, the post is a rectangular-shaped post with a height of 10 mm. As for the tip 305, it may have a height of 8 mm. Providing other dimensions for the rectangular-shaped post and the pointed tip may also be possible. Other cross-sectional shaped posts may also be useful. For example, the post may be shaped in the form of a cross or any other geometric shapes. In one embodiment, the tip 305 is shaped as an inverted cone. The inverted cone has a steep profile. For example, a vertex angle θ in the vertex of the cone may be 38 degrees. The vertex angle is configured to enable the tip to puncture effectively without exerting too much pressure. Providing other vertex angles may also be useful. Alternatively, it may also be useful to form a tip with other cross-sectional shapes or configurations.

In FIG. 3b, the post of the puncturing rod 301 may have a cross-sectional base area of 6 mm by 8 mm. As discussed, the posts of the puncturing rods occupy a region or a support rim 309 which is between the base plate opening and inner edge of the retainer. In one embodiment, the support rim may include an inner concentric ring 311 which coincides with the edge of the base plate opening. For example, the inner concentric ring 311 may have a same or similar diameter as the diameter of the base plate opening. For example, the diameter of the inner concentric ring is 30 mm. The support rim may include an outer concentric ring 313 which coincides with the edge of the retainer. For example, the outer concentric ring 313 may have a same or similar diameter as the inner diameter of the retainer. For example, the diameter of the outer concentric ring 313 is 36 mm. In one embodiment, the support rim has a width of 4 mm to accommodate puncturing rods having a cross-sectional base area of 48 mm². Alternatively, providing a support rim with other widths for accommodating puncturing rods with other cross-sectional base areas may also be useful.

In one embodiment, the overall length of the nozzle head is 93 mm. Other lengths may also be utilized for the nozzle head. The overall length allows the dispensing tube of the nozzle head to have a sufficient volume or depth and at the same time maintains a length of the fluid passage that does not require providing a pressure that exceeds what can be provided by the plunger.

As discussed above, in one embodiment, the nozzle head is an integrated or single piece. For example, various portions of the nozzle head, such as the first, second and third portions, the base plate and the retainer, are formed as a single piece part. Alternatively, the various components are formed separately and later integrated to form a single piece. In one embodiment, the puncturing rods are formed separately before they are integrated with the nozzle head. In another embodiment, the nozzle head with the puncturing rods is formed as a single piece. The nozzle head may be made of a rigid material, such as a rigid plastic. The plastic nozzle head may be molded into shape. For example, molding techniques such as casting or injection molding may be employed. Other types of rigid materials as well as other forming techniques, such as 3D-printing may also be useful. The same material and technique used to form the nozzle head may also be employed to form the puncturing rods. For example, the puncturing rods are formed from plastic that is shaped by molding techniques such as injection molding. Alternatively, other materials and techniques for forming the puncturing rods may also be utilized.

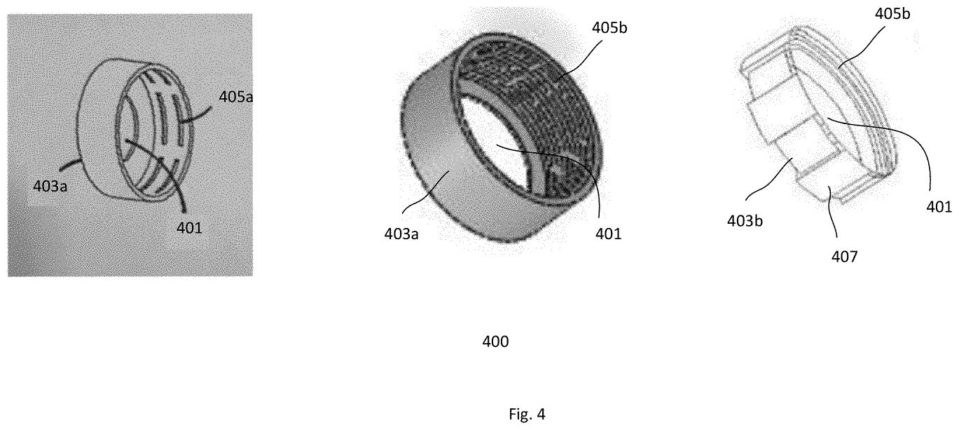

FIG. 4 shows views of various exemplary embodiments of a nozzle head lock ring 400. The nozzle head lock ring serves as a cap to secure the nozzle head to the barrel by coupling to the second barrel end. As such, when the sausage pack is pushed against the nozzle head, the nozzle head remains fixed in position and does not get displaced from the exerted pressure. For example, the nozzle head lock ring includes a lock ring plate with a lock ring coupler. The lock ring coupler is configured to be mated to a second barrel end coupler disposed at the second barrel end. This facilitates to lock the nozzle head lock ring, together with the nozzle head, to the second barrel end.

In one embodiment, the lock ring plate is a ring-shape. The lock ring plate is configured to slot through the dispensing tube of the nozzle head disposed on the second barrel end of the barrel. For example, the lock ring plate includes a dispensing tube hole 401 so that the lock ring plate can pass through the dispensing tube. In one embodiment, the dispensing tube hole has a diameter that is the same as or similar to the outside diameter of the barrel. For example, the diameter of the lock ring plate is 60 mm. An exterior surface of the lock ring plate 403a may be a flat exterior surface. Alternatively, providing a lock ring plate 403b having an exterior surface with raised flanges 407 may also be useful. The raised flanges provide a better grip control during twisting or rotating of the lock ring plate to lock the nozzle head.

The lock ring coupler may be disposed on an interior surface of the lock ring plate. In one embodiment, the lock ring coupler may be a male coupler while the second barrel end coupler may be a female coupler. For example, the couplers may be threaded couplers. The lock ring coupler may include threads configured to mate with grooves disposed around the second barrel end coupler at the second barrel end. Rotating the nozzle head lock ring in a first direction may lock the nozzle head lock ring into position whereas rotating the nozzle head lock ring in a second direction may decouple the nozzle head lock ring from the second barrel end. This locking configuration facilitates a tight sealing between the nozzle head and the barrel. Thereafter, caulking material is prevented from leaking out of the barrel. For example, caulking material can only exit through the nozzle outlet of the nozzle head.

In one embodiment, the threads of the lock ring coupler 405a are discontinuous threads. Alternatively, continuous threads that form concentric rings around the interior surface of a lock ring coupler 405b may be employed. The type of threads used on the lock ring coupler should match with the type of grooves disposed around the second barrel end coupler. For example, discontinuous threads should be mated with discontinuous grooves. The same applies for continuous threads. Alternatively, providing other configurations of the lock ring coupler and the second barrel end coupler may also be possible. Other types of couplers, such as twist lock couplers, may also be useful for securing the nozzle head to the barrel.

The following describes an exemplary method of assembling a caulking gun. A sausage pack containing caulking material is first inserted into a barrel of a conventional caulking gun. At this stage, a plunger of the caulking gun is reset to a resting position inside the barrel. For example, the plunger is positioned near the first barrel end. A plunger plate of the plunger is in contact with one end of the sausage pack.

A nozzle head is then capped over the second barrel end of the barrel. The nozzle head may be similar to that described in FIGS. 1, 2a-f, 3a-b. For example, the nozzle head is a puncturing nozzle head. The nozzle head may include a dispensing tube with a base plate and a retainer. For example, the dispensing tube may be formed of multiple portions. The multiple portions are connected to form a continuous fluid passage inside the dispensing tube. In one embodiment, the base plate, together with the retainer, houses a plurality of puncturing rods that are configured to puncture the sausage pack to release caulking material.

A nozzle head lock ring is then coupled to the second barrel end coupler positioned at the second barrel end to secure the nozzle head in position with the barrel. The nozzle head is locked to the barrel after a twisting motion or rotation of the nozzle head lock ring.

When the actuator of the caulking gun is in a dispense mode, the actuator moves the plunger to push the sausage pack towards the second barrel end. For example, the sausage pack is pushed against the nozzle head. Puncturing rods of the nozzle head pierce the sausage pack and create openings for caulking material to escape. In this way, the sausage pack can be unsealed without needing the operator to manually cut it open. This not only increases the working efficiency of the operator, but also minimized the operator's risk hazard.

Caulking material that escapes is then directed to flow towards the fluid passage within the dispensing tube of the nozzle head. As discussed above, the fluid passage is formed by a continuous connection between the multiple portions of the dispensing tube. Caulking material is then dispensed out of the nozzle head from the nozzle outlet.

The inventive concept of the present disclosure may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

1. A caulking device assembly comprising:
a barrel, the barrel having a first barrel end and a second barrel end, wherein the barrel is configured to contain a sausage pack sealed with caulking material;
a nozzle head including
a base plate having top and bottom surfaces,
a dispensing tube extending from the top surface of the base plate, the dispensing tube having a first end opening at the top surface of the base plate and a second end opening opposing the first end opening, and
a plurality of puncturing rods disposed on the bottom surface of the base plate;
a nozzle head lock ring, wherein the nozzle head lock ring is configured to lock the nozzle head in position at the second barrel end; and
wherein the puncturing rods at the bottom surface of the base plate is configured to puncture the sausage pack when the sausage pack is pressed against the puncturing rods to release the caulking material for dispensing out through the second end opening of the dispensing tube.

2. The caulking device assembly of claim 1, wherein the dispensing tube includes a tapered profile in which the first end opening is wider than the second end opening of the dispensing tube.

3. The caulking device assembly of claim 2, wherein the dispensing tube comprises multiple portions, the multiple portions include
an upper portion with a tip defining the second end opening of the dispensing tube, and
at least one lower portion with first and second end openings, wherein a lowermost portion is in communication with the base plate, wherein a first end opening of the lowermost portion forms the first end opening of the dispensing tube.

4. The caulking device assembly of claim 3, wherein a wall is disposed around and within an edge of the base plate to form a housing with the base plate, wherein the housing is configured to surround the puncturing rods.

5. The caulking device assembly of claim 4, wherein a height of the housing is configured to contain the puncturing rods within the housing.

6. The caulking device assembly of claim 3, wherein each puncturing rod comprises
a post disposed on the bottom surface of the base plate; and
a tip, wherein the tip is disposed at a second end of the post and distal from the bottom surface of the base plate.

7. The caulking device assembly of claim 6, wherein the post of each puncturing rod is a cross-shaped post.

8. The caulking device assembly of claim 1, wherein each puncturing rod comprises a rectangular-shaped post and an inverted-conical tip with a vertex angle of 38 degrees.

9. The caulking device assembly of claim 6, wherein the caulking device assembly is mechanically operated.

10. The caulking device assembly of claim 6, wherein the caulking device assembly is electrically operated.

11. The caulking device assembly of claim 6, wherein the caulking device assembly is pneumatically operated.

12. The caulking device assembly of claim 1, wherein the nozzle head lock ring is configured to fit through the nozzle head and mate with a second barrel end coupler disposed on the second barrel end to lock the nozzle head in position, wherein the nozzle head lock ring and the second barrel end coupler are threaded couplers.

13. A nozzle head of a caulking tool comprising:
a base plate having top and bottom surfaces;
a dispensing tube extending from the top surface of the base plate, the dispensing tube having a first end opening at the top surface of the base plate and a second end opening opposing the first end opening; and
a plurality of puncturing rods disposed on the bottom surface of the base plate, wherein when the nozzle head is fitted onto a caulking tool loaded with a sausage pack sealed with caulking material, the puncturing rods are configured to pierce the sausage pack pressed into the puncturing rods to dispense the caulking material through the second end opening of the dispensing tube.

14. The nozzle head of claim 13, wherein the dispensing tube includes a tapered profile in which the first end opening of the dispensing tube is wider than the second end opening of the dispensing tube.

15. The nozzle head of claim 14, wherein the dispensing tube comprises multiple portions, the multiple portions include
an upper portion with a tip defining the second end opening of the dispensing tube, and
at least one lower portion with first and second end openings, wherein a lowermost portion is in communication with the base plate, wherein a first end opening of the lowermost portion forms the first end opening of the dispensing tube.

16. The nozzle head of claim 13, wherein a wall is disposed around and within an edge of the base plate to form a housing with the base plate, wherein the housing is configured to surround the puncturing rods.

17. The nozzle head of claim 13, wherein each puncturing rod comprises
a post disposed on the bottom surface of the base plate; and
a tip, wherein the tip is disposed at a second end of the post and distal from the bottom surface of the base plate.

18. The nozzle head of claim 17, wherein the post of each puncturing rod is a cross-shaped post.

19. The nozzle head of claim 13, wherein when the nozzle head is fitted onto the caulking tool, a nozzle head lock ring is configured to lock the nozzle head in position to the caulking tool.

20. (canceled)

21. The nozzle head of claim 13, wherein each puncturing rod comprises a rectangular-shaped post and an inverted-conical tip with a vertex angle of 38 degrees.
